(19) United States
(12) Patent Application Publication
(10) Pub. No.: US 2002/0136624 A1
(43) Pub. Date: Sep. 26, 2002

(54) Lift device with variable speed actuation

(76) Inventor: Karapet Ablabutyan, Glendale, CA (US)

Correspondence Address: Manatt, Phelps & Phillips, LLP, 11355 West Olympic Boulevard, Los Angeles, CA, 90064, US

(21) Appl. No.: 09/815,878

(22) Filed: Mar. 22, 2001

(51) Int. Cl. B65G 43/00

(52) U.S. Cl. 414/556

(57) ABSTRACT

A lift device of the type appended to a vehicle such as a tailgate lift or wheelchair lift. The lift includes a platform movable between a lower or ground position, an upper or load position and stowed position. The platform assumes a horizontal orientation in the ground and load positions and is pivotable to a vertical orientation when stowed for vehicle movement. The platform is connected to a lever arm assembly and further includes hydraulic apparatus to move the platform between ground, load and stowed positions. The hydraulic apparatus is actuated by a pump and motor assembly which includes an electric motor for actuation of the pump and hydraulic apparatus. By varying the speed of the motor, the speed of the platform between various platform orientations can be varied.

### TECHNICAL FIELD OF INVENTION

The present invention is directed to a lift device of the type appended to and supported by a vehicle. Lift devices of this sort include, for example, wheelchair lift apparatus and tailgate lift apparatus. Through the practice of the present invention, the speed in raising and lowering and stowing such lift devices can be varied by varying the speed of an electrical motor rather than through the use of complex hydraulics as is practiced by the prior art.

### BACKGROUND OF THE INVENTION

There is a substantial body of art dealing with lift devices for the transport of wheelchair-bound handicapped persons, for the loading of cargo as a truck tailgate, and for the lifting of a vehicle for undercarriage repairs. Some tailgate lifts and some wheelchair lifts can be appended to the bottom of a vehicle chassis while others are supported at or about the rear or sidewall of the vehicle proximate the vehicle opening.

Wheelchair lift devices of the kind contemplated herein consist of components dictated principally by the need to capture and lift the wheelchair-bound passenger in a safe fashion as well as to enable the lift to fold or somehow be made unobtrusive when not in use. Devices of this kind are generally shown in a series of patents assigned to Ricon Corp. typified by U.S. Pat. No. 5,605,431 issued on Feb. 25, 1997, the disclosure of which is incorporated by reference herein. FIG. 1 depicts the typical platform motion of a wheelchair lift device of the type shown in the '431 patent. The wheelchair lift is illustrated in three positions, namely, a stowed position S (phantom lines) an entry position E (solid lines) and ground or loading position G (phantom lines). Hydraulic cylinders 38 each with an axially aligned piston rod 46, drive the parallelogram mechanism 13 to a closed configuration. Each piston rod 46 is pivotally connected to one of the parallel links 22 at the points of connection to channel arms 27. Opposite ends of each cylinder 38 are pivotally connected to the points of connection of lower parallel links with one of the armature brackets 28. Hydraulic system 14 also includes a pump assembly 36 affixed to the outside of the rear armature bracket 28 for support. Pump assembly 36 includes pump 40 to actuate cylinders 38, a motor 42 driving the pump and a reservoir 44 to supply and accept fluid to and from the hydraulic drive system 14.

As further noted by making reference to the '431 patent, from ground position G driven by cylinder rods 46, the parallelogram structure 17 swings upwardly until the platform 12 is level with the floor of the vehicle (position E). Parallelogram structure 17 maintains the platform 12 in a horizontal position as it is raised or lowered between ground level and vehicle floor or loading level.

It is generally recognized that it would be advantageous to have different speeds of motion depending upon the motion patterns of the wheelchair lift device. Specifically, when moving from the load to and from the stowed position, the platform 12 should generally proceed to move more slowly than when platform 12 is moving between ground G to and from entry or load position E. In fact, as noted in the '431 patent, there are 4 distinct operational patterns including (1) swing down from storage position, (2) horizontal movement to ground, (3) horizontal movement to vehicle and (4) swing to storage.

The hydraulics shown in the prior art, in order to carry out these various phases of operation, employ valving as disclosed as FIGS. 2 and 3 herein which represent FIGS. 3 and 5 of the '431 patent. Specifically, the prior art discloses the use of hydraulic control 41 as a unitary block body coupled between cylinders 38 and pump 40 which is in turn connected to reservoir 44. Pump 40 is active during various phases to store and raise the lift.

As further noted, control 41 defines three channels represented in FIG. 2 by passages 55, 56 and 57. The passage 55 defines an orifice 55A and contains a valve 55B. Similarly, the passage 56 defines an orifice 56A and contains a valve 56B. The passage 57 is unobstructed but carries a valve 57B. The functions of the passages are summarized by the prior art by noting that passage 55 allows flow in the direction to the left through a small orifice providing movement from entry or load position to the stowed position. The passage 56 to the right presents a large orifice for movement from the stowed position to the load position while passage 57 is bidirectional providing for the vertical raising and lowering of platform 12. As such, restricted passages 55 and 56 affect lift movement at reduced speeds, the orifice sizes compensating for the weight of the lift accounting for movement during swing down or deploy phases while the pump drives the lift during storage.

FIG. 3 of the prior art discloses use of block 60 employed in conjunction with hydraulic system 16. Block 60 accommodates fluid flow in multiple paths as described with regard to FIG. 2 enabling the lift to move at selective speeds. It is noted that block 39 includes staged bore 74 extending through block 39 from top to bottom. The top portion of the staged bore 74 forms a cavity 78 configured to receive a normally closed spool valve 80 actuated by a solenoid 82.

Perpendicular to bore 74 is an upper bore 72 extending from cavity 78 to the right-hand side of the block 39 as shown passing through a bore 69 at a right angle. A plug 72A seals the end of bore 72 opposite cavity 78. A staged bore 76 is provided extending from the lower end of 74 to the right-hand side of block 39. The orifice of bore 76 is closed by a threaded plug 77 and sealed by an O-ring 106. The stage of bore 76, proximate to the end that connects with 74, forms a tapered seat 86 for a normally seated movable member or orifice 88. The movable unidirectional flow, attenuating orifice 88, has a tapered section 90 to abut the seat 86 when seated. It is taught that the movable orifice 88 is biased against the seat 86 by a coil spring 100. One end of the spring 100 is recessed in a flow passage 96. The other end of the spring 100 abuts a contact surface 102 of a cartridge 104 set in the bore 76. An O-ring 104A seals the cartridge 104 in bore 76.

The prior art continues by disclosing orifice 105, through the portion of the cartridge proximate the contact surface which intersects with the transverse bore 68 and together they connect the bore 76 to bore 70. The relatively small orifice 94 and movable orifice 88 have a diameter that is smaller than orifice 105 and cartridge 104. These orifices coincide to the representative orifices 55A and 56A, respectively. The bore 70, disposed parallel to the bore 74, extends from the top of block 39 and intersects bore 72 and terminates in the mid-portion of a bore 76, connecting the bore 72 and 76. A plug 70a seals the entry of bore 70 opposite the bore 76. A bore 69, coupled to pump 40, lies orthogonal to the plane formed by bores 70 and 72. The bore 69 extends from the intersection of bores 70 and 72 to the surface of block 39. As such, various fluid paths are created having selected lines of reduced cross-section and a movable orifice in order to control the speed of movement between stowed and unstowed positions and between ground and entry level positions of platform 12. Similar hydraulic pathways can be created in controlling the speed of movement of a tailgate lift as the platform goes from ground to truck bed level at one speed, is stowed against the force of gravity at a second speed and swings from vertical to horizontal orientations with the aid of gravitational attraction when unstowed.

It is not difficult to appreciate that hydraulic systems such as those shown in the '431 patent are complex to manufacture and can be problematic to maintain as moving orifices which are spring biased can hang up and not operate properly over time while hydraulic lines of reduced cross-section can clog if foreign debris finds its way into the hydraulic system. Furthermore, restricting hydraulic orifices as the prior art patent calls out has a harmful effect on the electric motor in that it raises the amperage draw making it work harder. The device of the present invention eliminates this.

It is thus an object of the present invention to provide a hydraulic system for actuating lift devices which is less complex to manufacture and less prone to malfunction than comparable devices of the prior art.

This and further objects will be more readily apparent when considering the following disclosure and appended drawings.

### SUMMARY OF THE INVENTION

The present invention involves a lift device of the type appended to a vehicle. Tailgate and wheelchair lift devices typify those contemplated for use herein which are provided with a platform movable between a lower or ground position, upper, load or entry position and stowed position. The platform assumes a substantially horizontal orientation in the ground and load positions and is pivotable to a substantially vertical orientation when stowed for the vehicle movement.

A platform is connected to a lever arm assembly further including hydraulic apparatus to move the platform between ground, load and stowed positions. The hydraulic apparatus is actuated by a pump and adjustable speed motor assembly for actuating the pump and hydraulic apparatus so that the speed of motion of the platform is controlled by the speed of the motor. This obviated the need for complex valve restrictions as employed by the prior art.

### BRIEF DESCRIPTION OF THE DRAWINGS

FIG. 1 is a schematic showing movement of a lift device through various operational positions of the prior art.

FIG. 2 depicts schematically hydraulic lines of varying cross-section for controlling hydraulic fluid flow in order to actuate the device of FIG. 1.

FIG. 3 is a cross-sectional view again showing various lines for hydraulic flow including a moving orifice.

FIG. 4 is an electrical schematic of one embodiment of the present invention.

FIG. 5 is a schematic of the hydraulic system of the present invention.

FIG. 6 is a perspective view of a vehicle lift capable of employing the present invention.

### DETAILED DESCRIPTION OF THE INVENTION

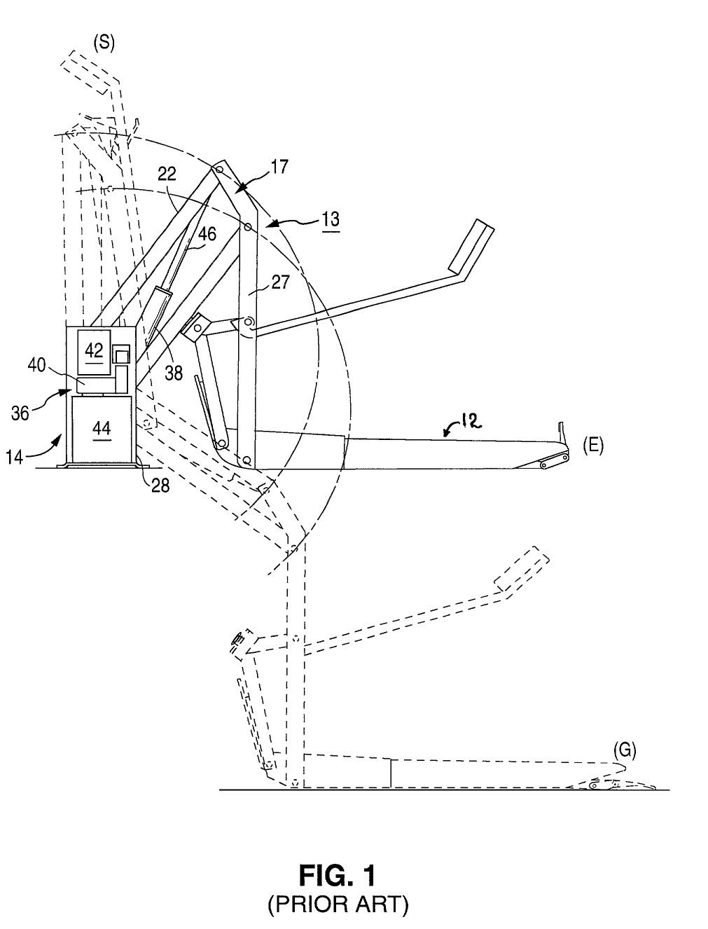

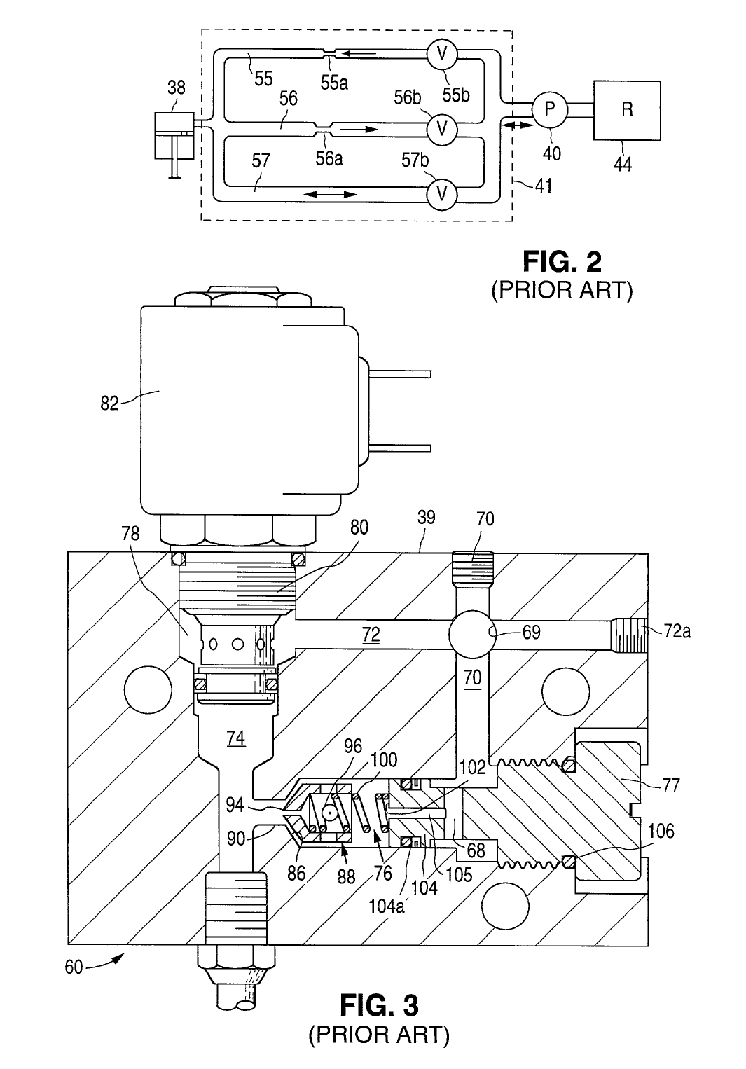

The present disclosure does not depict a wheelchair lift apparatus other than that shown as prior art in FIG. 1 for the actual wheelchair lift apparatus in the form of a platform, parallelogram linkage and hydraulic cylinder do not change from structures shown in the prior art incorporating the present invention. Specifically, the present invention continues to employ mobile platform 12, hydraulic system 14 and parallelogram mechanism 13. As in the prior art, the operation of the lift involves hydraulic ram or cylinder 38 which operates in the upper parallelogram structure 17 to open and close the parallelogram. Lower parallelogram structure 19 retains an open configuration during the transporting or raising-lowering motion patterns but collapses or closes during the storage motion pattern as a result of its engagement with upper parallelogram structure 17.

In addition to the use of a pump assembly such as assembly 36 of the prior art affixed to the outside of rear armature bracket 28 for support, the present invention also includes the equivalent of pump 40 to actuate cylinders 38 and a motor 42 to drive the pump and reservoir 44 to supply and accept fluid to and from hydraulic drive system 14. Where the present invention differs from the prior art is the use of variable speed motor 42 in order to accurately control the speed of pump 40 and therefore the pressure of hydraulic fluid within hydraulic cylinders 38. Through the use of variable speed motor 42, the moving orifice of FIG. 3 and hydraulic lines of varying dimension can be eliminated thus significantly simplifying actuation of platform 12 between its different orientations eliminating the need for a very costly valve component.

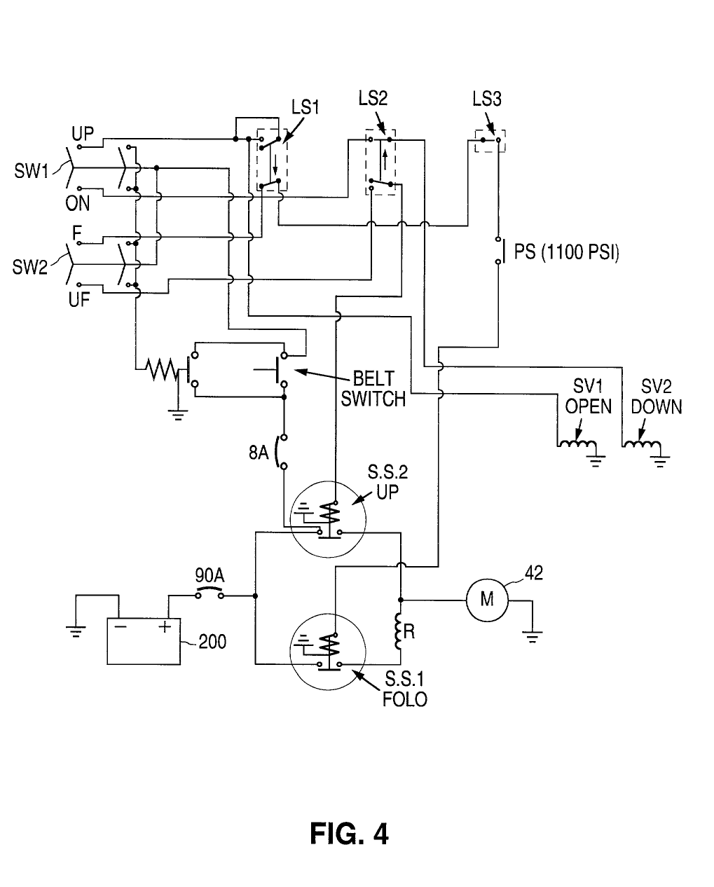

In further detail, an electrical schematic of one embodiment of the present invention is shown in FIG. 4. In this embodiment, the electric motor 42 is a standard DC motor. The operation of the lift is controlled by two switches SW1 and SW2. By design, only one of these switches can be in the “ON” position at a given time. Switch SW1 operates to raise or lower the lift, and switch SW2 folds and unfolds the lift. Three position switches LS1, LS2 and LS3 operate to enable or disable the various possible movements of the lift, depending upon the position of the lift. The position switches also control the speed of the electric motor. For example, if switch SW1 is “ON” and the lift is in the maximum “UP” position, then the position switches LS1 and LS2 operate to apply appropriate control signals to the two solenoid valves SV1 and SV2 to lower the lift. Similarly, if the lift is completely folded, and switch SW2 is selected, the position switches LS1 and LS2 operate to apply the appropriate signals to the two solenoid valves SV1 and SV2 to “unfold” the lift.

The effective electric motor speed is controlled by a combination of two switches SS1, SS2 and a resistance R. The two speed switches SS1 and SS2 are, in turn, controlled by the position switches LS2 and LS3. If switch SS1 is enabled by the position switch LS3, a DC voltage from the battery 200 is reduced by the series resistance R, thereby reducing the speed of the motor 42 This slow speed is used when the lift is being folded. However, if switch SS2 is enabled by the position switch LS2, the battery 200 is directly connected to the motor 42, resulting in a higher speed of operation. The higher speed is used to raise or lower the lift to and from ground level. Thus, the electrical controls provide two different operational speeds, depending upon the relative position of the lift.

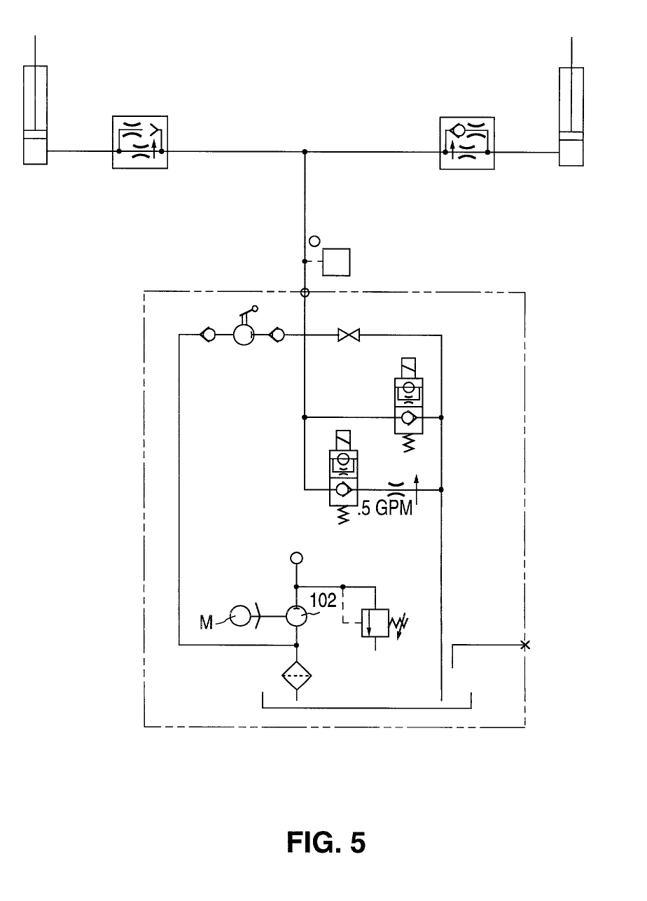

FIG. 5 is a schematic of the hydraulic system according to the present invention. However, instead of having complicated valving to control the speed of the lift, the valves are of a fixed design, and the speed is controlled by controlling the speed of the motor pumping the hydraulic fluid. Specifically, the electric motor 42 connects to a gear pump to pump the hydraulic fluid in the system. The hydraulic cylinder connection to the lift is as depicted in the prior art.

As noted previously, the present invention is also adaptable for use in a folding tailgate lift system of the type shown in Maxon Industries' U.S. Pat. No. 4,836,736, the disclosure of which is incorporated by reference.

The application of the variable speed motor to a typical tailgate lift mirrors that of the wheelchair lift previously discussed. This is because a tailgate lift goes through the same operational movements of stow/deploy and up and down as does a wheelchair lift.

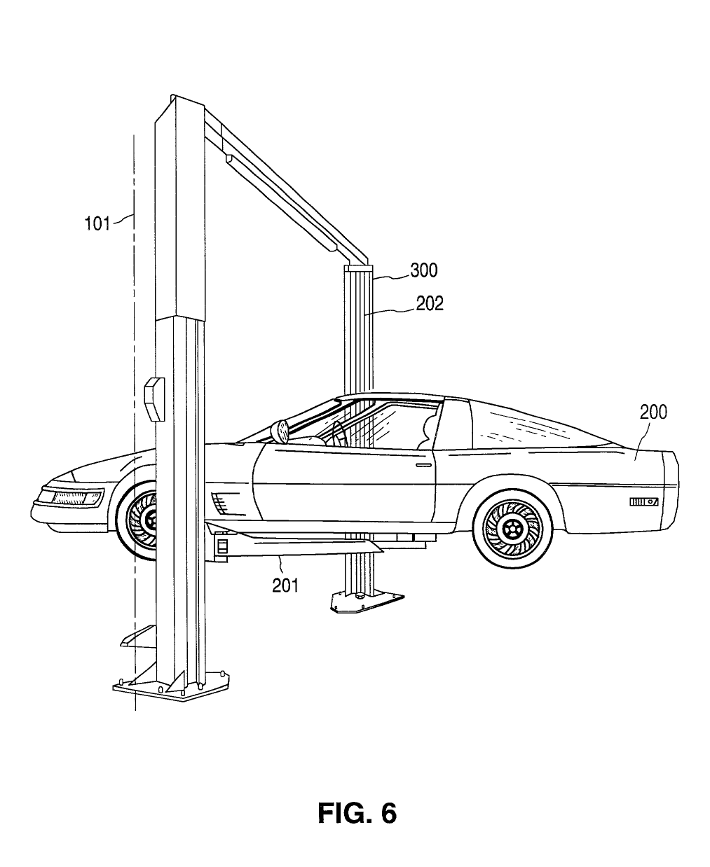

Also, as previously noted, the variable speed motor discussed above can also be employed in an automobile lift assembly of the type found in garages for under chassis work. Such lifts, as shown in FIG. 6, move only along a single vertical axis 101, but it is oftentimes desirable to vary the speed of lifting and collapse for safety reasons. This can be accomplished through the use of the present invention without need for complex plumbing or restricted orifices. Specifically, vehicle 200 is caused to be supported on foldable support brace 201. Support brace 201 moves along channel 202 located within each upright frame member 300. Movement of support brace 201 within channel 202 can be done by use of hydraulic cylinders (not shown) located within each upright frame member 300. The present variable speed motor can cause support brace 201 to, for example, lift vehicle 200 faster than the vehicle is lowered for safety reasons.

What is claimed is:

1. In a lift device of the type appended to a vehicle, said lift device having a platform movable between a lower or ground position, upper or load position and stowed position, said platform assuming a substantially horizontal orientation in said ground and load position and pivotable to a substantially vertical orientation when stowed for vehicle movement, said platform being connected to a lever arm assembly and further including hydraulic apparatus to move said platform between ground, load and stowed positions, said hydraulic apparatus being actuated by a pump and motor assembly, the improvement comprising providing an electric motor with control circuitry for actuation of said pump and hydraulic apparatus so that speed of motion of the platform is directly proportional to the speed of said motor.

2. The lift device of claim 1 wherein said lever arm assembly comprises at least one parallelogram structure.

3. The lift device of claim 1 wherein said speed of said motor is selected so that said platform moves more slowly when pivoting from horizontal to vertical orientations than when said platform moves from ground to load.

4. The lift device of claim 1 wherein said lift device is a wheelchair lift.

5. The lift device of claim 1 wherein said lift device is a tailgate lift.

6. In a lift device of the type used to raise a vehicle vertically for enabling ready access to the vehicle's undercarriage, said lift device comprising a platform for supporting a vehicle movable from ground to an elevated position and back to ground again, the improvement comprising providing an electric motor with control circuitry or actuation of a pump and hydraulic apparatus so that speed of motion of said platform is directly proportional to the speed of the motor.
